(19) United States
(12) Patent Application Publication
(10) Pub. No.: US 2026/0162052 A1
(43) Pub. Date: Jun. 11, 2026

(54) MULTI-SENSORY TRAILER-LOAD CHARACTERIZATION

(71) Applicant: Toyota Motor Engineering & Manufacturing North America, Inc., Plano, TX (US)

(72) Inventors: Akila C. Ganlath, Fremont, CA (US); Qi Chen, San Jose, CA (US); Sergei S. Avedisov, Redwood City, CA (US); Ahmadreza Moradipari, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/971,523

(22) Filed: Dec. 6, 2024

(51) Int. Cl. G06Q 10/0835; G06Q 10/047

(52) U.S. Cl. CPC G06Q 10/08355; G06Q 10/047

(57) ABSTRACT

Systems and methods described herein relate to generating a load spatial model, determining vehicle dynamics associated with load transport, generating a load transport model based on the load spatial model, a vehicle spatial model, and the vehicle dynamics, determining a route by estimating costs of transporting a load based on the load transport model, and determining a trajectory following the route based on the load transport model and motion constraints.

### TECHNICAL FIELD

The subject matter described herein relates, in general, to strategies for multi-sensory trailer-load characterization for efficient and safe towing.

### BACKGROUND

The towing of irregular or oversize loads involves transporting vehicles, machinery, or other large loads that may exceed standard size and weight limits for a road system. For example, regulations may specify that loads exceeding a designated width, height, length, or weight limits are oversized and require special permits and other precautions. Such special permits or precautions may require the use of specialized trailers, escort vehicles, route planning, and other considerations. In addition, tailers and loads having an irregular shape, mass distribution, or both can be difficult to safely tow in the presence of wind and other dynamic conditions.

### SUMMARY

In one embodiment, a vehicle management system is disclosed. The vehicle management system includes one or more processors and a memory communicably coupled to the one or more processors. The memory stores a command module including instructions that when executed by the one or more processors cause the one or more processors to generate a load spatial model, determine vehicle dynamics associated with load transport, generate a load transport model based on the load spatial model, a vehicle spatial model, and the vehicle dynamics, determine a route by estimating costs of transporting a load based on the load transport model, and determine a trajectory following the route based on the load transport model and motion constraints.

In one embodiment, a non-transitory computer-readable medium including instructions that when executed by one or more processors cause the one or more processors to perform one or more functions is disclosed. The instructions include instructions to generate a load spatial model, determine vehicle dynamics associated with load transport, generate a load transport model based on the load spatial model, a vehicle spatial model, and the vehicle dynamics, determine a route by estimating costs of transporting a load based on the load transport model, and determine a trajectory following the route based on the load transport model and motion constraints.

In one embodiment, a method is disclosed. In one embodiment, the method includes generating a load spatial model, determining vehicle dynamics associated with load transport, generating a load transport model based on the load spatial model, a vehicle spatial model, and the vehicle dynamics, determining a route by estimating costs of transporting a load based on the load transport model, and determining a trajectory following the route based on the load transport model and motion constraints.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a load management system that is associated with trailer-load characterization strategies.

FIG. 3 illustrates one embodiment of a cloud computing environment within which the systems and methods described herein may operate.

FIG. 4 illustrates one example of an example of 3D data charactering the shape of a load.

FIG. 5 illustrates one example of a spatial model of a load.

FIG. 6 illustrates one embodiment of a load management system.

FIG. 7 illustrates one example of a method for multi-sensory trailer-load characterization for efficient and safe towing.

### DETAILED DESCRIPTION

Systems, methods, and other embodiments associated with multi-sensory trailer load characterization are described herein. Towing irregular or oversized loads can be challenging and present issues with respect to stability and control (e.g., oversized loads can destabilize the towing vehicle, leading to swaying and loss of control); visibility and maneuverability (e.g., oversized loads tent to obstruct visibility and require precise maneuvering); and legal compliance (e.g., when a height of an oversized vehicle is greater than 18 feet, a pilot height pole car with a vertical pole adjusted to the height of load may be required to lead the vehicle).

The systems and methods described herein may leverage multi-modal sensing, sensor fusion, and machine learning to characterize a vehicle-trailer-load system model. It may then use the learned representation of the trailer-load system to perform route planning and motion planning.

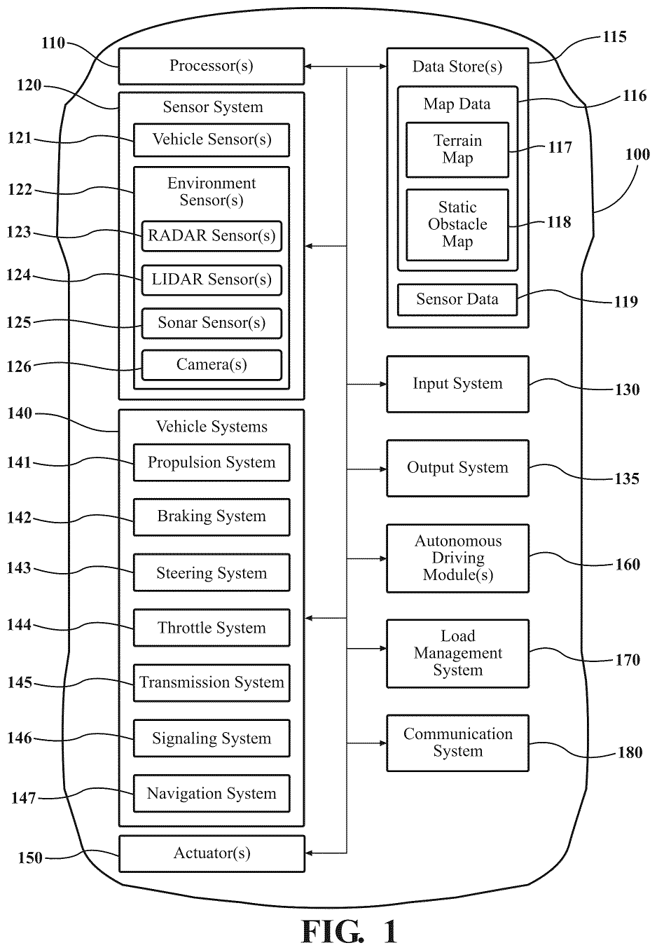

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein associated with load management strategies. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

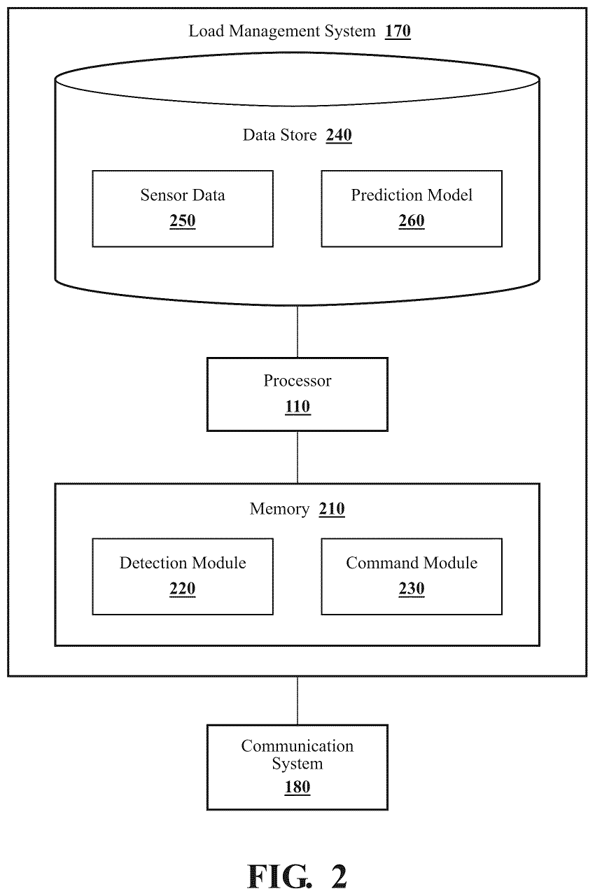

Some of the possible elements of vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a load management system 170 that is implemented to perform methods and other functions as disclosed herein. As will be discussed in greater detail subsequently, load management system 170, in various embodiments, is implemented partially within vehicle 100 and as a cloud-based service. For example, in one approach, functionality associated with at least one module of load management system 170 is implemented within vehicle 100 while further functionality is implemented within a cloud-based computing system.

With reference to FIG. 2, one embodiment of load management system 170 of FIG. 1 is further illustrated. Load management system 170 is shown as including processors 110 from vehicle 100 of FIG. 1. Accordingly, processors 110 may be a part of load management system 170, load management system 170 may include a separate processor from processors 110 of vehicle 100, or load management system 170 may access processors 110 through a data bus or another communication path. In one embodiment, load management system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processors 110 cause processors 110 to perform the various functions disclosed herein.

Load management system 170 as illustrated in FIG. 2 is generally an abstracted form of load management system 170 as may be implemented between vehicle 100 and a cloud-computing environment. Accordingly, load management system 170 may be embodied at least in part within a cloud-computing environment to perform the methods described herein.

With reference to FIG. 2, detection module 220 generally includes instructions that function to control processors 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on.

In one embodiment, detection module 220 may also acquire sensor data 250 from one or more sensors that allows for the detection of load characteristics for a load that will be transported by a vehicle or trailer. For example, load data may be comprised of any sensor data 250 that may be relevant to the determination of the size (e.g., height, width, length), weight, density, or any other static or dynamic property of a load that may affect vehicle operation before, during, or after transport. A load may be any form of cargo or freight that is transported on a trailer, on a vehicle (e.g., in a pickup truck bed), or as a detachable part of a trailer or vehicle.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link from one or more of the surrounding vehicles or other sources (e.g., via V2V, V2I, V2X), or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, load management system 170 includes a database 240. Database 240 is, in one embodiment, an electronic data structure stored in memory 210 or another data store and that is configured with routines that may be executed by processors 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processors 110 to obtain load characteristics as described herein. In some embodiments, detection module 220 may receive and store load characteristics.

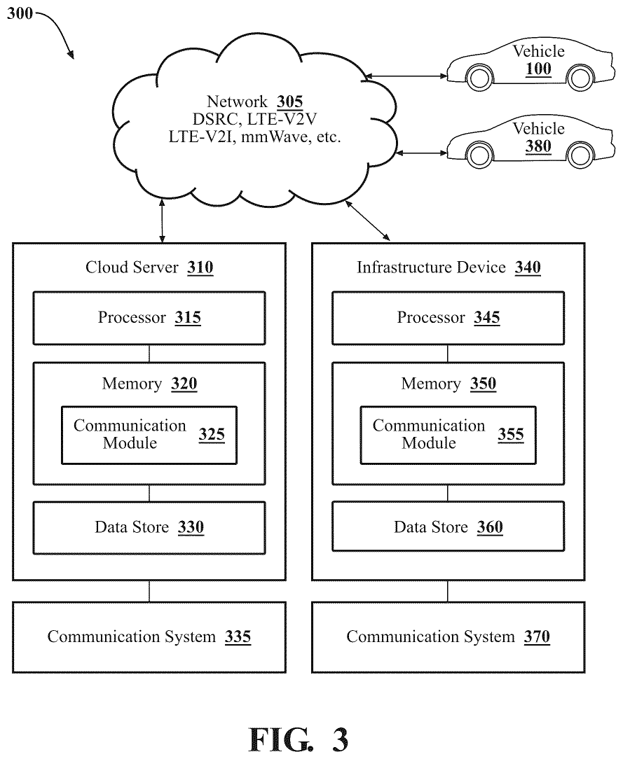

In one embodiment, command module 230 generally includes instructions that function to control the processors 110 or collection of processors in the cloud-computing environment 300 as shown in FIG. 3.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of load management system 170 through network 305 via communication unit 335 (e.g., a network router or bridge). In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of load management system 170 through network 305 via communication unit 370 (e.g., a network router or bridge). In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, load management system 170 may obtain information from cloud servers (e.g., cloud server 310), infrastructure devices (e.g., infrastructure device 340), other vehicles (e.g., vehicle 380), and any other systems connected to network 305. For example, cloud servers (e.g., cloud server 310) may be used to perform the same tasks as described herein with respect to command module 230.

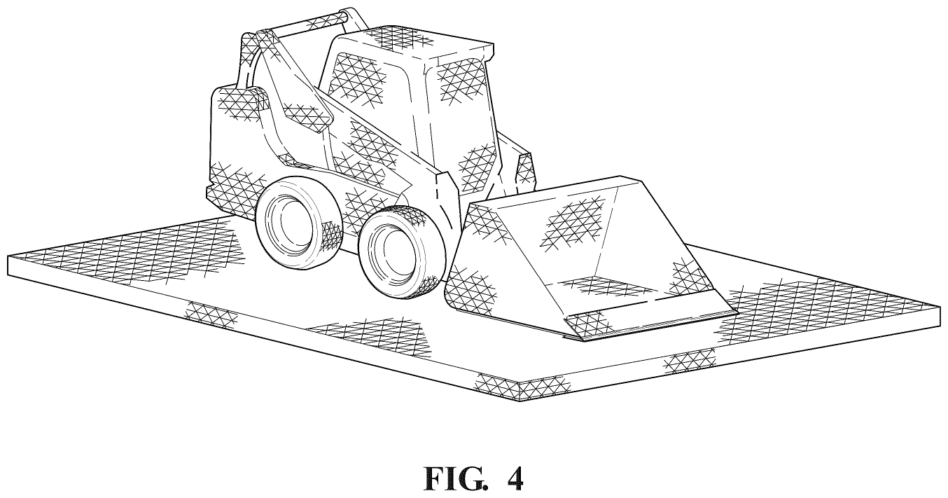

In some embodiments, command module 230 may characterize the shape of a load. For example, command module 230 may utilize vision sensors, radar sensors, ultrasonic sensors, and so on to obtain 2D or 3D data (e.g., images) about the shape of a load (e.g., height, length, width). Such 2D or 3D data may be taken from different viewpoints around the load, such as by 2D or 3D data captured by smart devices, back-up cameras, panoramic monitor view cameras, camera drones, etc. Command module 230 may also receive 2D or 3D data about the shape of a load from other vehicles, infrastructure devices, etc. With respect to FIG. 4, an example of 3D image data characterizing the shape of the load is shown.

In some embodiments, the load may physically or electronically provide shape information that allows for specifying the shape of a load. For instance, the load may provide an identifier that provides data about the shape of a load (e.g., trailer dimension markings) or a method of accessing such data electronically (e.g., RFID tags, QR codes). In some embodiments, command module 230 may obtain such shape information from the load and may then confirm that such shape information is accurate, such as by a comparison with sensor data.

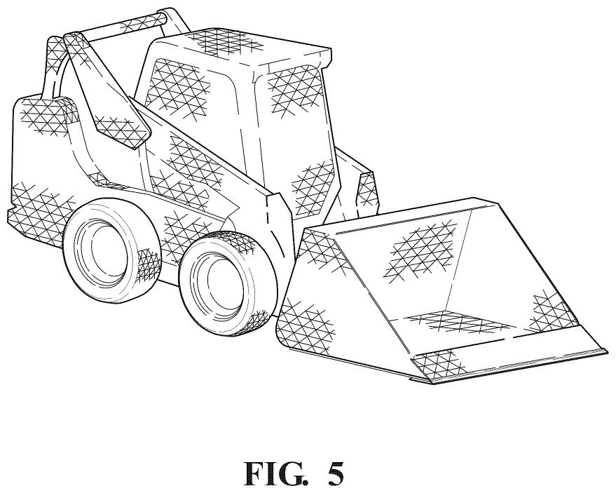

In some embodiments, based on the 2D or 3D data about the shape of a load command module 230 may form a spatial model of the load (e.g., a 3D mesh of the load). For example, command module 230 may use Neural Radiance Fields (NeRF) to generate a 3D representation of a load based on the 2D or 3D data about the shape of a load. Command module 230 may then take the volumetric data of the NeRF-generated 3D model of the load to form a 3D mesh of the load, such as by using NeRF Meshing. As another example, command module 230 may use Panopticon Neural Fields (PNFs) to generate a 3D representation of a load based on the 2D or 3D data about the shape of a load. Command module 230 may then take the volumetric data of the PNF-generated 3D model of the load to form a 3D mesh of the load, such as by using PNF Meshing. With respect to FIG. 5, an example of a spatial model of a load is shown.

In some embodiments, command module 230 may also characterize the shape of a vehicle; obtain shape information from a vehicle; form a spatial model of a vehicle; and so on using the same systems and methods described herein with respect to loads. For example, a vehicle manufacturer may provide a 3D mesh of a towing vehicle that command module 230 may use as a spatial model of a tractor, but command module 230 may use NeRF and NeRF Meshing to form a 3D mesh of the trailer for use as a spatial model of the trailer (e.g., because no spatial model is available from the trailer manufacturer).

In some embodiments, command module 230 may characterize vehicle dynamic properties in association with transporting a load. For example, command module 230 may utilize Inertial Motion Units (IMUs), traction load sensors, hitch torque sensors, and so on to obtain information describing how a load affects the vehicle dynamics of a trailer, vehicle, or combination thereof (e.g., a tractor-trailer configuration). These sensors may provide data that allows command module 230 to evaluate drag, mass, moment of inertia, material characteristics, packaging arrangement, or other properties that may cause a load to affect vehicle dynamics.

For example, based on the shape model of a load, command module 230 may determine a drag coefficient of the load, which may be further enhanced based on sensor data regarding surface texture of the load or the use of flow visualization tools (e.g., tufts attached to a load). As another example, IMUs may allow command module 230 to estimate a moment of inertia or the mass of a load (e.g., by evaluating the force exerted by the vehicle in relation to the load and its resulting acceleration). As another example, camera sensors may allow command module 230 to determine the material characteristics of a load (e.g., metal, wood) or the packaging arrangement of the load (e.g., a double stack of two standard shipping containers), which may affect the chassis flex or other characteristics of a trailer carrying such a load.

In some embodiments, command module 230 may receive information electronically (e.g., from a load, a user, the cloud) that contains data allowing command module 230 to determine how a load may affect vehicle dynamics. For example, a load may provide information about the temperature, density, or other physical properties of a gas or liquid, the manner of storage (e.g., a tank of a certain size with baffles constructed in a specific manner), dynamic models describing the load (e.g., how a gas or liquid flows within the baffled tank in response to acceleration), etc. In some embodiments, command module 230 may instruct a vehicle to perform various maneuvers so that sensors can collect data regarding how the load affects the vehicle dynamics of a vehicle.

In some embodiments, command module 230 may also characterize the vehicle dynamics of a vehicle that is not currently transporting a load. For example, command module 230 may use data from IMUs or other sensors to characterize the vehicle dynamics of a vehicle when it is not transporting a load. Based on such vehicle dynamics, command module 230 may evaluate whether a vehicle is operating within acceptable parameters to transport a load prior to it being loaded on the vehicle; is in need of repair or reconfiguration; etc.

In some embodiments, command module 230 may form a load transport model, which may contain a spatial model of a load, a spatial model of one or more vehicles transporting the load (e.g., pick-up truck, tractor-trailer), and any vehicle dynamic properties associated with the transport of the load. The load transport model may then be used by automated driving module(s) 160 when implementing different levels of automation, including advanced driving assistance functions, semi-autonomous functions, and fully autonomous functions.

Command module 230 may include a machine learning module (e.g., Automated driving module(s) 160) using methods such as deep neural networking, autoregressive modeling, symbolic learning, parameter fitting models, etc. Command module 230 may also receive sensor data (e.g., data from IMU, traction load, hitch torque, etc.) and using the machine learning module to output updated vehicle dynamics. Such updates may be implemented by command module 230 because of a triggering event, such as receiving new sensor data from other connected autonomous vehicles, detecting a disturbance such as an abnormal oscillating/amplification frequency in the lateral movement of a trailer or towing vehicle, or detecting a reduced quality of motion control based on a load transport model. As another example, if a portion of the load is removed, command module 230 may detect such removal and update the load transport model with new information regarding the spatial model of the load; the vehicle dynamic properties associated with the transport of the altered load; etc. As another example, a user may instruct command module 230 that a load, such as an overweight load, has been removed from within a trailer, which may cause command module 230 to update a load transport model in terms of the vehicle dynamic properties associated with the transport of the load (e.g., adjusting the model based on the reduced weight of the trailer and any remaining load). As yet another example, command module 230 may estimate the energy consumption of transporting a load during transit and the estimated remaining range as the load is transported by the one or more vehicles and include those estimates in the load transport model.

In some embodiments, command module 230 may also include cost functions or models in a load transport model, which may describe the cost of transporting the load by the one or more vehicles. For example, cost functions or models may allow command module 230 to determine one or more estimates of resource consumption in transporting the load, such as time costs, labor costs, financial costs, energy costs, etc. when performing various vehicle maneuvers during load transport. For example, a load transport model may contain cost functions for the loading and unloading of the load from a vehicle (e.g., time costs, labor costs). As another example, a load transport model may contain cost functions for maintaining environmental conditions of a load during transport (e.g., cooling, heating). As another example, a load transport may contain cost functions describing loss of value for time-sensitive deliveries (e.g., perishable goods, contractual penalties).

In some embodiments, command module 230 may receive a routing map. A routing map may consist of any information relevant to the potential routing of one or more vehicles transporting a load. For example, the routing map may include information as to road restrictions on vehicle height, width, length, weight, etc. As another example, the routing map may include information as to the position, width, length or other physical characteristics of lanes, intersections, or any other area defined by road markings, curbs, or other indicators, such as for example on/off ramps, merge zones, road shoulders, etc. As another example, the routing map may include information as to adjacent objects along a roadway that may restrict transport of oversized loads (e.g., signs, lights, fences, mailboxes, utility boxes, fire hydrants, trees or other vegetation, safety barriers) or crossover objects that cross over a roadway (e.g., bridges, power lines, traffic lights, signs). Such adjacent objects, crossover objects, or both may be characterized by their position, size, shape, clearance height, cost of removal/replacement, safety risks, etc.

In some embodiments, command module 230 may update a routing map based on sensor data. For example, command module 230 may instruct that an area be surveyed by drones, autonomous vehicles, staff with smart devices, etc. and then use that data to update a routing map, such as recording any changes in the presence of adjacent objects, crossover objects, or both.

As another example, command module 230 may update a routing map to include estimates of load bearing capacity of various regions of the routing map (e.g., by classifying regions according to surface types (e.g., grass, concrete, asphalt, mud, gravel, rock) and estimating a load bearing capacity based on such a surface type.

As another example, command module 230 may update a routing map to include hazard awareness data, such as identifying regions of erosion, earthquake damage, flooding, structural damage or collapse, or any other factors that may pose a hazard or potential risk to transporting a load through an area. For example, command module 230 may receive satellite images and drone data allowing command module 230 to determine where hazards have arisen due to a disaster (e.g., road rubble, fire, collapsed buildings) and indicate that such areas are impassable. In some embodiments, command module 230 may also estimate a cost to clear such hazards (e.g., in terms of time, financial resources, labor, etc.) so that an area becomes passable. For example, based on sensor data regarding the height of rubble and its estimated composition (e.g., concrete rubble), command module 230 may estimate how long one or more construction vehicles would need to clear such rubble from a road.

In some embodiments, command module 230 may determine a set of route planning constraints, where such route planning constraints may seek to minimize various costs (e.g., time, labor, financial) or place limitations on such costs (e.g., not to exceed). For example, a set of route planning constraints may specify that time and financial cost are to be minimized, but that labor costs must remain fixed at a pre-defined amount.

In some embodiments, command module 230 may determine one or more routes for transporting a load based on a load transport model, a set of route planning constraints, and a routing map. For example, if an oversized load requires more time to complete a turn the smaller an intersection, command module 230 may minimize the use of smaller intersections to avoid increased time costs. In determining the one or more routes, command module 230 may use an iterative deep learning algorithm to evaluate the load transport model, route planning constraints, and the routing map, which may further include evaluating any costs as described herein to satisfy the route planning constraints.

In determining the one or more routes, command module 230 may simulate, in whole or in part, the transport of a load according to its transport model through one or more regions of a routing map. For example, command module 230 may utilize one or more spatial models within a load transport model to determine the extent of clearance or conflict that will occur with an adjacent object or crossover object when transporting the load through an area; the type and number of any vehicle maneuvers required to transport the load through an area (e.g., the number of three-point turns required to turn at an intersection); and so on. As another example, command module 230 may utilize the weight of the load (or total weight of the load and a vehicle) to determine the extent that such weight may preclude transport of the load through an area; pose risk of excessive wear or damage to a road surface; and so on.

In some embodiments, command module 230 may determine the costs (e.g., time, labor, financial) of transporting the load through an area based on the transport model and the routing map. For example, command module 230 may determine the cost of transporting an overweight load on a road surface lacking sufficient load bearing capacity, such as a financial cost to repair such a road surface due to accelerated wear or damage. As another example, command module 230 may determine if any conflicts with roadway objects or crossover objects exist if a load is transported through a region, including any cost associated with the temporary or permanent removal of such an object as an impediment to transport, based on the physical dimensions provided by a load transport model. As another example, based on a load transport model command module 230 may determine regulatory requirements, including any compliance costs, for transporting a load through an area (e.g., lead or following pilot cars for oversized loads on highways). As another example, based on a load transport model command module 230 may determine the cost of a turn (e.g., time, road closures, labor costs) at an intersection when transporting a load through an area. As another example, based on a load transport model command module 230 may determine the cost of elevation changes (e.g., in terms of energy costs) when transporting a load through an area.

In some embodiments, command module may also take additional information into account when determining costs, such as traffic congestion, best practices, safety considerations, etc. For example, command module 230 may determine the cost of road closures due to the transit of a load through a region, such as delays imposed on other vehicle operators. As another example, command module 230 may determine the cost of requiring specialized personnel (e.g., police, fire, EMS, vehicle or crowd control services) that may need to be present if a load transits a region.

In some embodiments, command module 230 may determine a set of motion planning constraints, where such motion planning constraints specify limitations on vehicle maneuvers involving the transport of a load. For example, motion planning constraints may specify a minimum lateral spacing (e.g., lateral distance from any object or another vehicle), a minimum longitudinal spacing (e.g., minimum longitudinal distance from any object or another vehicle), maximum speed, maximum turning angle, maximum turn speed, maximum surface gradient, etc.

In some embodiments, command module 230 may generate a local area map for tracking an environment and objects therein in real-time as a load is transported through an area. For example, the local area map may be initially based on a portion of the routing map and then updated by command module 230 based on sensor data to include the presence of dynamic objects (e.g., vehicles, people, animals), any changes in static objects (e.g., adjacent objects, crossover objects), any changes in environmental conditions (e.g., rain, smoke, fire), and so on.

In some embodiments, command module 230 may constrain the transport of a load based on the motion planning constraints. For example, command module 230 may utilize the information regarding adjacent objects, crossover objects, dynamic objects, etc. to ensure that spacing requirements in the motion planning constraints are not violated. In evaluating the motion planning constraints, command module 230 may determine one or more trajectories for transporting a load, such as a trajectory that will maximize the distance of the load from any nearby objects, a trajectory that will ensure a minimum distance of the load from nearby objects, and so on. In some embodiments, command module 230 may generate a trajectory by use of a technique such as rapidly-exploring random trees to evaluate potential trajectories via the load transport model, the motion planning constraints, and the local area map. In some embodiments, command module 230 may use automated driving module(s) 160 to implement a trajectory generated by command module 230.

In some embodiments, command module 230 may determine the extent of any deviation from the trajectory based on sensor data. In some embodiments, if a deviation exceeds a pre-determined range, command module 230 may issue instructions causing the transport of a load to be paused or slowed down. For example, if wind gusts cause a vehicle transporting a load to deviate from a trajectory, command module 230 can pause or slow down the transport of the vehicle to allow for course corrections though implementation of a new trajectory. As another example, if deviation exceeds a threshold while transporting an overweight load, command module 230 may halt transport of the load and instruct a vehicle operator to inspect ground conditions or to provide a corrective remedy (e.g., traction mats, recovery tracks). As yet another example, a deviation above a threshold may cause command module 230 to perform vehicle maneuvers that allow for updating the vehicle dynamics of the load transport model to be more accurate (e.g., adjusting vehicle dynamics based on new vehicle maneuvers because a change in slope has shifted the center of gravity).

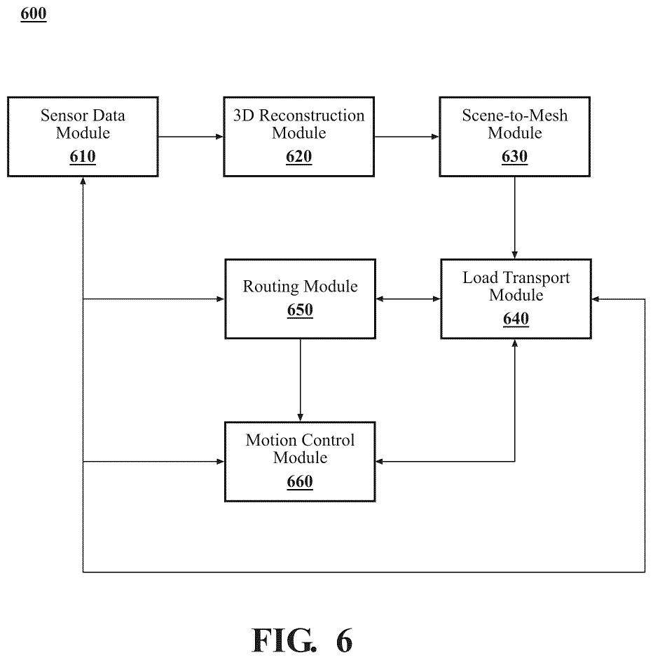

With respect to FIG. 6, an example of a system 600 for load management is shown. Sensor data module 610 may generate or receive 2D or 3D data characterizing the shape of a load. For example, sensor data module 610 may obtain such data from sensor data 250. 3D reconstruction module 620 may then take the 2D or 3D data charactering the shape of a load and form a 3D reconstruction of the load. Scene-to-mesh module 630 may then take the 3D reconstruction of the load to form a spatial model of the load, which may then be added to load transport model maintained by load transport module 640. Load transport module 640 may also receive a vehicle spatial model and vehicle dynamics (e.g., from sensor data 250), which may then be used to update the load transport model.

The load transport mode model may be used by the routing module 650 to determine a route as described herein. Routing module 650 may also receive additional information from sensor data 250 or other modules (e.g., map data, object data, surface data). The route selected may then be provided to motion control module 660, which may also use the load transport model and additional information from sensor data 250 or other modules (e.g., map data, object data, surface data), to control the vehicle (e.g., through automated or semi-automated driving). In addition, motion control module 660 may act to provide updates to the load transport module 640, such as updates regarding vehicle dynamics.

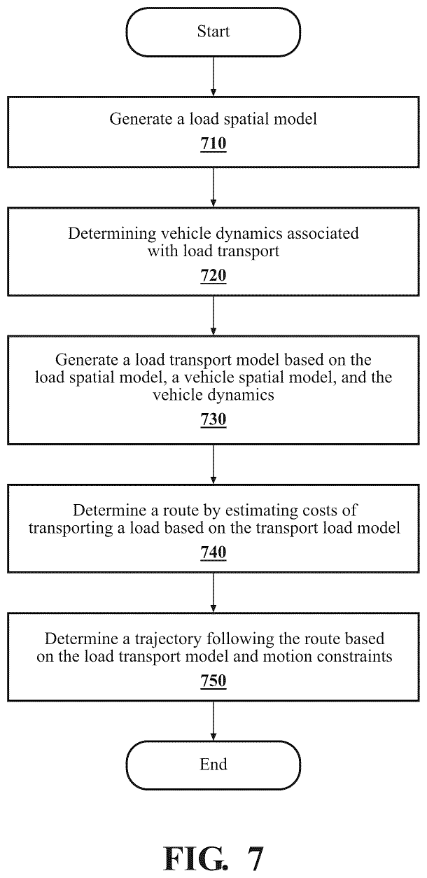

FIG. 7 illustrates a flowchart of a method 700 that is associated with using load management strategies. Method 700 will be discussed from the perspective of the load management system 170 of FIGS. 1 and 2. While method 700 is discussed in combination with the load management system 170, it should be appreciated that the method 700 is not limited to being implemented within load management system 170 but is instead one example of a system that may implement method 700.

At step 710, command module 230 may generate a load spatial model. For example, a vehicle operator may operate a drone to take 2D images and video of the load. These images and video may then be processed by command module 230 to generate a scene depicting the load, which is then converted to a spatial model by command module 230 (e.g., by using scene-to-mesh software).

At step 720, command module 230 may determining vehicle dynamics associated with load transport. For example, command module 230 may instruct the vehicle to perform a set of maneuvers that allow it to determine a variety of vehicle dynamics. In addition, command module 230 may also perform vehicle maneuvers allowing for additional sensor data from other devices, such as a weight bridge.

At step 730, command module 230 may generate a load transport model based on the load spatial model, a vehicle spatial model, and the vehicle dynamics. For example, based on a mesh model of the load, a manufacturer model of the vehicle, and the vehicle dynamics obtained in step 720, command module 230 may create a load transport model that may be used to manage the transport of the load by the vehicle.

At step 740, command module 230 may determine a route by estimating costs of transporting a load based on the load transport model. For example, command module 230 may use the spatial models within a load transport model to ensure that the lowest cost route is taken from a starting point to a desired destination. Based on the load transport model, various costs may be considered by command module 230, such as the estimated number of turns and time required to maneuver through intersections or around objects.

At step 750, command module 230 may determine a trajectory following the route based on the load transport model and motion constraints. For example, based on real-time or near real-time sensor data, command module 230 may determine a trajectory that avoids static or dynamic objects, unstable surfaces, and so on. Command module 230 may then instruct the vehicle transporting the load (e.g., vehicle 100) to follow the trajectory. Based on how the vehicle transporting the load is able to follow the trajectory, command module 230 may make corrections by issuing a new trajectory, updating the vehicle dynamics, or other corrective actions as described herein.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, load management system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, load management system 170, automated driving module(s) 160, or any combination thereof may control some or all of these vehicle system(s) 140 and, thus, may be partially or fully autonomous.

Processor(s) 110, load management system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, load management system 170, automated driving module(s) 160, or any combination thereof may control the direction, speed, or both of vehicle 100. Processor(s) 110, load management system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving modules 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with load management system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

1. A system, comprising:
a processor; and
a memory communicably coupled to the processor and storing machine-readable instructions that, when executed by the processor, cause the processor to:
generate a load spatial model of an oversized load;
determine vehicle dynamics affected by the oversized load;
generate a load transport model based on the load spatial model, a vehicle spatial model, and the vehicle dynamics;
determine a route by estimating costs of transporting the oversized load based on the load transport model; and
instruct a vehicle to follow the route while complying with motion planning constraints that, in accordance with sensor data, protect the oversized load.

2. The system of claim 1, wherein the machine-readable instructions to generate the load spatial model utilizes camera images taken from multiple perspectives around the oversized load to generate a 3D mesh.

3. The system of claim 1, wherein the machine-readable instructions to determine the route for the oversized load includes estimating an oversize cost imposed by an oversized load.

4. The system of claim 3, wherein the machine-readable instructions to determine the route for the oversized load includes estimating the oversize cost in relation to maneuvering the oversized load through an area.

5. The system of claim 1, wherein the machine-readable instructions to determine the route includes estimating an overweight cost imposed by an overweight load.

6. The system of claim 5, wherein the machine-readable instructions to determine the route includes estimating the any wear or damage caused by transporting the oversized load through an area.

7. The system of claim 1, wherein the machine-readable instructions to instruct a vehicle to follow the route while complying with motion planning constraints includes simulating whether the load spatial model travels within a pre-determined distance of a nearby object.

8. A non-transitory computer-readable medium including instructions that when executed by one or more processors cause the one or more processors to:
generate a load spatial model of an oversized load;
determine vehicle dynamics affected by the oversized load;
generate a load transport model based on the load spatial model, a vehicle spatial model, and the vehicle dynamics;
determine a route by estimating costs of transporting the oversized load based on the load transport model; and
instruct a vehicle to follow the route while complying with motion planning constraints that, in accordance with sensor data, protect the oversized load.

9. The non-transitory computer-readable medium of claim 8, wherein the instruction to generate the load spatial model utilizes camera images taken from multiple perspectives around the oversized load to generate a 3D mesh.

10. The non-transitory computer-readable medium of claim 8, wherein the instruction to determine the route for the oversized load includes estimating an oversize cost imposed by an oversized load.

11. The non-transitory computer-readable medium of claim 10, wherein the instruction to determine the route for the oversized load includes estimating the oversize cost in relation to maneuvering the oversized load through an area.

12. The non-transitory computer-readable medium of claim 8, wherein the instruction to determine the route includes estimating an overweight cost imposed by an overweight load.

13. The non-transitory computer-readable medium of claim 12, wherein the instruction to determine the route includes estimating the any wear or damage caused by transporting the oversized load through an area.

14. A method, comprising:
generating a load spatial model of an oversized load;
determining vehicle dynamics affected by the oversized load;
generating a load transport model based on the load spatial model, a vehicle spatial model, and the vehicle dynamics;
determining a route by estimating costs of transporting the oversized load based on the load transport model; and
instructing a vehicle to follow the route while complying with motion planning constraints that, in accordance with sensor data, protect the oversized load.

15. The method of claim 14, wherein generating the load spatial model utilizes camera images taken from multiple perspectives around the oversized load to generate a 3D mesh.

16. The method of claim 14, wherein determining the route for the oversized load includes estimating an oversize cost imposed by an oversized load.

17. The method of claim 16, wherein determining the route for the oversized load includes estimating the oversize cost in relation to maneuvering the oversized load through an area.

18. The method of claim 14, wherein determining the route includes estimating an overweight cost imposed by an overweight load.

19. The method of claim 18, wherein determining the route includes route includes estimating the any wear or damage caused by transporting the oversized load through an area.

20. The method of claim 19, wherein instruct a vehicle to follow the route while complying with motion planning constraints includes simulating whether the load spatial model travels within a pre-determined distance of a nearby object.
